(19) United States
(12) Patent Application Publication
(10) Pub. No.: US 2026/0342125 A1
(43) Pub. Date: Oct. 29, 2026

(54) UNINTERRUPTIBLE POWER SUPPLY

(71) Applicant: SANTAK ELECTRONIC (SHENZHEN) CO., LTD., SHENZHEN (CN)

(72) Inventors: Dongyu ZHANG, Shenzhen (CN); Dongxiao CHEN, Shenzhen (CN); Shuqin ZHUANG, Shenzhen (CN)

(21) Appl. No.: 19/653,174

(22) Filed: Apr. 21, 2026

(30) Foreign Application Priority Data
Apr. 24, 2025 (CN) 202510530133.8

(51) Int. Cl. H02J 9/06

(52) U.S. Cl. CPC H02J 9/062; H02J 9/068

(57) ABSTRACT

An uninterruptible power supply includes an input terminal, an output terminal, a communication module, and a controller. The input terminal is configured to be electrically connectable to a first alternating current power supply. The output terminal is configured to be electrically connectable to an output switch that is configured to be electrically connectable to a system load. The communication module is communicatively connected to additional uninterruptible power supplies electrically connected between the power supply and the system load and is configured to obtain operating modes of the additional uninterruptible power supplies. The controller is configured to determine a switch state of the output switch based on at least one of an output voltage and an output frequency of the uninterruptible power supply and a load current, an output current of the uninterruptible power supply, and operating modes of the uninterruptible power supply and the additional uninterruptible power supplies.

### CROSS REFERENCE TO RELATED APPLICATIONS

This application claims benefit to Chinese Patent Application No. CN202510530133.8, filed on Apr. 24, 2025, which is hereby incorporated by reference herein.

### FIELD

The present disclosure relates to the field of power supplies, and in particular, to an uninterruptible power supply.

### BACKGROUND

The statements in this part are merely intended to provide background information related to the present disclosure, to help understand the present disclosure. The background information does not necessarily constitute the prior art.

Among modern power supply systems, uninterruptible power supplies (UPSs) are a type of important power protection device widely used in fields such as computers, communication network systems, industrial control systems, and industrial devices that require continuous operation. A core function of the UPSs is to provide stable and uninterruptible power supply for key devices, to ensure that the devices can operate normally in case of utility power failures or abnormalities, and to avoid data loss or device damage caused by power-related issues.

Specifically, an uninterruptible power supply mainly includes an input terminal, an output terminal, a main branch, a battery branch, and a discrete bypass from the input terminal to the output terminal of the uninterruptible power supply, where the main branch is composed of an AC-DC conversion module (rectifier), a DC-AC conversion module (inverter), and the like; and the battery branch is composed of a battery, a DC-DC conversion module (charging module) for charging the battery, and a DC-DC conversion module (discharging module) for performing direct current conversion on an output voltage of the battery. Generally, the input terminal of the uninterruptible power supply is configured to be connected to an alternating current power supply (such as utility power), and the output terminal is configured to be connected to a system load (such as an electrical device in a data center) through an output switch. By such configuration, when the utility power is normal, the UPS, such as an online UPS, can rectify an alternating current into a direct current to charge the battery, and convert a direct current into a stable alternating current through the inverter to supply power to the system load simultaneously; and when the utility power is interrupted, the battery continues to supply power to the system load through the discharging module and the inverter, thereby ensuring uninterrupted operation of a load device.

### SUMMARY

In an embodiment, the present disclosure provides an uninterruptible power supply, including an input terminal configured to be electrically connectable to a first alternating current power supply; an output terminal configured to be electrically connectable to one side of an output switch that is, on the other side of the output switch, configured to be electrically connectable to a system load; and a communication module communicatively connected to additional uninterruptible power supplies electrically connected between the first alternating current power supply and the system load. The corresponding output switch is connected in series between each uninterruptible power supply among the additional uninterruptible power supplies and the system load, and the communication module is configured to obtain operating modes of the additional uninterruptible power supplies, the operating modes including a power conversion mode, a battery mode, a bypass mode, and a power-off mode. The uninterruptible power supply also includes a controller configured to determine a switch state of the output switch based on i) at least one of an output voltage and an output frequency of the uninterruptible power supply and a load current of the system load, ii) an output current of the uninterruptible power supply, and iii) operating modes of the uninterruptible power supply and the additional uninterruptible power supplies.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic circuit diagram of a UPS and a UPS parallel system thereof according to an embodiment of the present disclosure;

FIG. 2 illustrates a schematic circuit diagram of a UPS and a UPS parallel system thereof according to an embodiment of the present disclosure;

FIG. 3A illustrates a partial flowchart of a control method for an uninterruptible power supply according to an embodiment of the present disclosure; and

FIG. 3B illustrates another partial flowchart of a control method for an uninterruptible power supply according to an embodiment of the present disclosure.

### DETAILED DESCRIPTION

An aspect of the present disclosure provides an uninterruptible power supply, including:
an input terminal, configured to be electrically connectable to a first alternating current power supply;
an output terminal, configured to be electrically connectable to one side of an output switch, and the other side of the output switch is electrically connectable to a system load;
a communication module, where the communication module is communicatively connected to other uninterruptible power supplies electrically connected between the first alternating current power supply and the system load, a corresponding output switch is connected in series between each uninterruptible power supply among the other uninterruptible power supplies and the system load, the communication module is configured to obtain operating modes of the other uninterruptible power supplies, and the operating modes include a power conversion mode, a battery mode, a bypass mode, and a power-off mode; and
a controller, where the controller is configured to determine a switch state of the output switch based on
   i) at least one of an output voltage and an output frequency of the uninterruptible power supply and a load current of the system load,
   ii) an output current of the uninterruptible power supply, and
   iii) operating modes of the uninterruptible power supply and the other uninterruptible power supplies.

According to an aspect of the uninterruptible power supply of the present disclosure, the controller is further configured to: determine the switch state of the output switch based on i) any two or three of the output voltage and output frequency of the uninterruptible power supply and the load current of the system load, ii) the output current of the uninterruptible power supply, and iii) the operating modes of the uninterruptible power supply and the other uninterruptible power supplies.

According to an aspect of the uninterruptible power supply of the present disclosure, the controller is further configured to: compare the load current with a first current threshold and the output current with a second current threshold respectively when the uninterruptible power supply and the other uninterruptible power supplies are in the power conversion mode or the battery mode, and determine that the switch state of the output switch is open when the load current is greater than the first current threshold and the output current is less than the second current threshold.

According to an aspect of the uninterruptible power supply of the present disclosure, the controller is further configured to: compare the output frequency with a first frequency threshold and the output frequency with a second frequency threshold respectively when the uninterruptible power supply and the other uninterruptible power supplies are in the power conversion mode or the battery mode, and determine that the switch state of the output switch is open when the output frequency is less than the first frequency threshold or the output frequency is greater than the second frequency threshold.

According to an aspect of the uninterruptible power supply of the present disclosure, it further includes a discrete bypass, where an input side of the discrete bypass is electrically connected to a second alternating current power supply, and an output side of the discrete bypass is electrically connected to the output terminal; where the controller is further configured to: compare a bypass frequency of the discrete bypass with a first frequency range, and determine that the switch state of the output switch is open when the output frequency is less than the first frequency threshold or the output frequency is greater than the second frequency threshold and the bypass frequency is within the first frequency range.

According to an aspect of the uninterruptible power supply of the present disclosure, the controller is further configured to: compare the output current with the second current threshold, and determine that the switch state of the output switch is open when the output frequency is less than the first frequency threshold or the output frequency is greater than the second frequency threshold and the output current is less than the second current threshold.

According to an aspect of the uninterruptible power supply of the present disclosure, the controller is further configured to: compare the output voltage with a first voltage threshold and the output current with the second current threshold respectively when the uninterruptible power supply is in the power-off mode and some of the other uninterruptible power supplies are in the power conversion mode or the battery mode, and determine that the switch state of the output switch is open when the output voltage is less than the first voltage threshold and the output current is less than the second current threshold.

According to an aspect of the uninterruptible power supply of the present disclosure, the controller is further configured to periodically determine the switch state of the output switch according to a preset determination cycle.

According to an aspect of the uninterruptible power supply of the present disclosure, the controller is further configured to indicate the switch state of the output switch to a user after at least two consecutive determinations that the switch state of the output switch is open.

According to an aspect of the uninterruptible power supply of the present disclosure, the first current threshold is a sum of rated output currents of the uninterruptible power supply and the other uninterruptible power supplies, the second current threshold is determined based on the rated output current of the uninterruptible power supply, the first frequency threshold and the second frequency threshold are determined based on an output frequency of the first alternating current power supply, and the first frequency range is determined based on an output frequency of the second alternating current power supply.

Aspects of the present disclosure construct a dynamic decision-making mechanism based on multi-dimensional parameter collaborative analysis by obtaining key parameters such as an output current, an output voltage, and an output frequency of an uninterruptible power supply, a bypass frequency, a load current of a system load, and operating modes of other uninterruptible power supplies in a UPS parallel system of the uninterruptible power supply, thereby achieving accurate determination on an output switch state, and innovative breakthrough on multiple bottlenecks of output switch state detection technology in existing UPS parallel systems. Compared with the prior art, aspects of the present disclosure leverage the inherent characteristics of uninterruptible power supplies to replace hardware sensors with software algorithms, thereby not only eliminating technical obstacles in device adaptation, installation, and maintenance, saving relevant manpower and material resources, but also fundamentally overcoming technical defects of hardware sensors such as signal delay, poor contact, and weak anti-interference capability, and enabling quick and accurate determination of the output switch state.

To make the aspects, technical solutions, and advantages of the present disclosure clearer, the following further describes the present disclosure in detail through specific embodiments with reference to the accompanying drawings. It should be understood that the described embodiments are some of, but not all of the embodiments of the present disclosure. All other embodiments obtained by those of ordinary skill in the art based on the embodiments of the present application without creative efforts shall fall within the protection scope of the present application.

In addition, the described features, structures, or characteristics may be incorporated in one or more embodiments in any suitable manner. In the following description, many specific details are provided to give a sufficient understanding of the embodiments of the present disclosure. However, those skilled in the art would appreciate that the technical solutions of the present disclosure may be practiced without one or more specific details, or other methods, components, apparatuses, steps, and the like may be employed. In other cases, well-known methods, apparatuses, implementations, or operations are not shown or described in detail to avoid obscuring various aspects of the present disclosure.

The block diagrams shown in the drawings are merely functional entities, and do not necessarily correspond to physically independent entities. These functional entities can be implemented in a software form, or in one or more hardware modules or integrated circuits, or in different networks and/or processor apparatuses and/or microcontroller apparatuses.

The flowcharts shown in the drawings are merely exemplary illustrations, do not necessarily include all content and operations/steps, and also do not have to be executed in the described order. For example, some operations/steps may be decomposed, while some operations/steps may be merged or partially merged, so the actual execution order may vary according to actual situations.

With the deep integration of information technology and industrial automation, critical infrastructure has put forward higher requirements for the reliability and capacity of power supply systems. Power supply technology solutions based on a plurality of uninterruptible power supplies (UPSs) in parallel have been widely applied in scenarios such as data centers, communication hubs, and industrial production lines. Compared with single-point fault risks of conventional stand-alone UPS systems, an N+1 or multi- UPSs parallel topology structure significantly improves the continuous power supply guarantee capability through redundancy design. In a parallel system of a plurality of UPSs (hereinafter referred to as UPS parallel system), corresponding output switches, connected in series between the UPSs and system loads respectively, can play roles in circuit on/off control, overload protection, short-circuit protection, fault isolation, facilitating system debugging, testing and maintenance, and improvement on system flexibility, and are key components in the UPS parallel system. For example, when a UPS is faulty, the corresponding output switch needs to be quickly cut off to isolate the faulty UPS. After the fault is repaired, the output switch can be controlled to close to seamlessly connect the UPS to the UPS parallel system.

The present inventors have found in long-term practice that a plurality of technical bottlenecks exist in the switch state detection technology for the output switches of the current UPS parallel system. Firstly, because the output switches are generally selected and installed independently by users, there are differences in models, incompatible interface standards, and diverse installation methods among devices of different brands, making it difficult for standardized adaptation of sensors or detection circuits configured to detect switch states, thereby resulting in unsatisfactory accuracy in switch state detection. Secondly, conventional detection methods rely on passive detection of sensors installed at physical locations of the corresponding output switches, resulting in a significant drawback: each UPS requires independent configuration of sensors and detection circuits, which not only doubles hardware costs, but also makes long-distance signal cables exposed to complex environments susceptible to mechanical damage (such as rodent damage, vibration wear), electromagnetic interference, or environmental corrosion, resulting in signal transmission interruptions. More importantly, the implementation of conventional detection solutions heavily relies on early intervention of a distribution system improvement phase. If UPS suppliers fail to participate in distribution network planning, it will be difficult to install and configure sensors at the corresponding physical locations of the output switches in the later stage. Moreover, independent detection channels configured for the respective UPSs not only result in repeated occupation of detection circuit resources, but also exacerbate space resource consumption and wiring complexity due to parallel laying of a plurality of signal transmission lines.

In view of the foregoing challenges in switch state detection of output switches in the UPS parallel system, the present disclosure proposes an innovative uninterruptible power supply and a control method thereof, which can break through the reliance on physical sensors in conventional solutions, and achieve hardware cost optimization and intensive utilization of space resources while ensuring reliability.

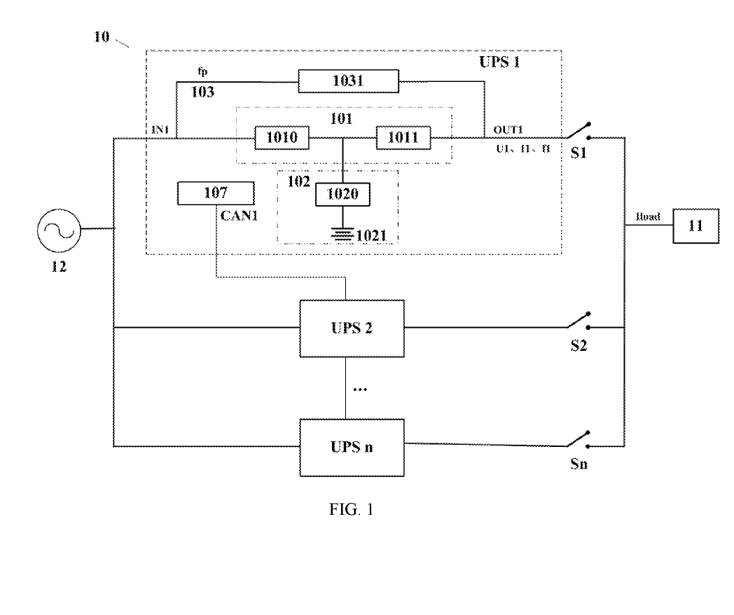

FIG. 1 illustrates a schematic circuit diagram of a UPS and a UPS parallel system thereof according to an embodiment of the present disclosure. As shown in FIG. 1, a UPS parallel system 10 includes n uninterruptible power supplies UPS 1 to UPS n connected in parallel between a first alternating current power supply 12 and a system load 11. Wherein, a corresponding one of the output switches S1 to Sn is connected in series between the output terminal of each UPS among the n uninterruptible power supplies UPS 1 to UPS n and the system load 11. Generally, the uninterruptible power supplies UPS 1 to UPS n are provided by a UPS manufacturer, while the output switches S1 to Sn are provided by a user of the UPS parallel system. Wherein, as shown in FIG. 1, taking UPS 1 as an example, it includes an input terminal IN1, an output terminal OUT1, a main branch 101, a battery branch 102, a discrete bypass 103, a controller 107, and a communication module CAN1. Wherein, the input terminal IN1 of UPS 1 is configured to be electrically connected to the first alternating current power supply 12 (for example, utility power), the output terminal OUT1 of UPS 1 is configured to be electrically connected to one side of the output switch S1, and the other side of the output switch S1 is configured to be electrically connected to the system load 11. The communication module CAN1 is communicatively connected to other uninterruptible power supplies (such as UPS 2 to UPS n) electrically connected between the first alternating current power supply 12 and the system load 11. As shown in FIG. 1, in this embodiment, the communication module CAN1 is connected to the other uninterruptible power supplies in a wired manner. The communication module CAN1 is configured to obtain operating modes of the other uninterruptible power supplies UPS 2 to UPS n. The other uninterruptible power supplies UPS 2 to UPS n have similar configurations to UPS 1. The controller 107 is configured to control UPS 1 and determine a switch state of the output switch S1 based on the following parameters:
at least one or any two or three of an output voltage U1 and an output frequency f1 of the uninterruptible power supply UPS 1 and a load current Iload of the system load 11;
an output current I1 of the uninterruptible power supply UPS 1; and
operating modes of the uninterruptible power supply UPS 1 and the other uninterruptible power supplies UPS 2 to UPS n.

The present inventors have found that through these parameters, the state of the output switch S1 can be effectively determined without additionally providing any sensor for detecting the switch state. When the switch is closed, the output voltage U1 and frequency f1 of the current UPS should match those of a load side, and the output current I1 should flow normally. If it is detected that the current UPS has voltage but no current (I1=0) or low current, or these contradict a due operating state of the operating mode of the current UPS, it indicates that the output switch may be open. Therefore, by analyzing logical relationships between electrical parameters (voltage, current, frequency) and system operating modes, the switch state can be reliably determined without any physical sensor, thereby reducing costs and simplifying detection structures.

In some embodiments of the present disclosure, preferably, the controller 107 is configured to obtain or collect the above parameters in real time.

In some embodiments of the present disclosure, preferably, the communication module CAN1 of the uninterruptible power supply UPS 1 is connected to the other uninterruptible power supplies in a wireless manner. Wherein, the communication module CAN1 obtains the operating modes of the other uninterruptible power supplies through wireless communication with them. In this way, the uninterruptible power supply UPS 1 can obtain the operating mode information of the other uninterruptible power supplies in real time and efficiently without complex wiring, thereby greatly reducing installation costs and maintenance difficulties. In some embodiments of the present disclosure, the main branch 101 includes a rectifier module 1010 and an inverter module 1011 sequentially connected between the input terminal IN1 and output terminal OUT1 of UPS 1. The battery branch 102 includes a charging/discharging module 1020 and a battery 1021, and the battery branch 102 is configured to be electrically connected to a node between the rectifier module 1010 and the inverter module 1011. The discrete bypass 103 includes a bypass switch 1031 for controlling on and off of the discrete bypass 103, and the discrete bypass 103 is configured in parallel with the main branch 101.

The operating modes of the uninterruptible power supply usually include a power conversion mode, a battery mode, a bypass mode, and a power-off mode. When UPS 1 is in the power conversion mode, the rectifier module 1010 is configured to convert an alternating current output by the first alternating current power supply 12 into a direct current and provide the direct current to the inverter module 1011 and the charging/discharging module 1020, the inverter module 1011 is configured to convert the received direct current into an alternating current and provide the alternating current to the system load 11, and the charging/discharging module 1020 is configured to perform direct current conversion on the received direct current to charge the battery 1021. When UPS 1 is in the battery mode, the charging/discharging module 1020 is configured to perform direct current conversion on a direct current output by the battery 1021 and provide the converted direct current to the inverter module 1011, and the inverter module 1011 is configured to convert the input direct current into an alternating current and provide the alternating current to the load 11. When UPS 1 is in the bypass mode, the bypass switch 1031 is closed, and the first alternating current power supply 12 supplies power to the system load 11 through the discrete bypass 103, and the current does not flow through the main branch 101 and the battery branch 102 anymore. When UPS 1 is in the power-off mode, UPS 1 stops operating.

In some embodiments of the present disclosure, the controller 107 may further be configured to: compare the load current Iload with a first current threshold Ith1 and the output current I1 with a second current threshold Ith2 respectively when the uninterruptible power supply UPS 1 and the other uninterruptible power supplies UPS 2 to UPS n are in the power conversion mode or the battery mode; and determine that the switch state of the output switch S1 is open when the load current Iload is greater than the first current threshold Ith1 and the output current I1 is less than the second current threshold Ith2.

In some embodiments of the present disclosure, the first current threshold Ith1 may be a sum of rated output currents of the uninterruptible power supply UPS 1 and the other uninterruptible power supplies UPS 2 to UPS n, and preferably, Ith1=n*I, where n represents the number of UPSs connected in parallel in the UPS parallel system 10, and I represents a rated current of the UPS in the UPS parallel system 10; the second current threshold Ith2 may be determined based on the rated output current of the uninterruptible power supply UPS 1, and preferably, Ith2=2%*I, where I represents a rated current of the uninterruptible power supply UPS 1.

In some embodiments of the present disclosure, the controller 107 may further be configured to: compare the output frequency f1 with a first frequency threshold fth1 and the output frequency f1 with a second frequency threshold fth2 respectively when the uninterruptible power supply UPS 1 and the other uninterruptible power supplies UPS 2 to UPS n are in the power conversion mode or the battery mode, and determine that the switch state of the output switch S1 is open when the output frequency f1 is less than the first frequency threshold fth1 or the output frequency f1 is greater than the second frequency threshold fth2.

In some embodiments of the present disclosure, the first frequency threshold fth1 and the second frequency threshold fth2 may be determined based on an output frequency of the first alternating current power supply 12, and the first frequency threshold fth1 is less than the second frequency threshold fth2. Preferably, fth1=f1*(1–m), and fth2=f1*(1+m), where f1 represents the output frequency of the first alternating current power supply 12, and m may be determined based on actual operating conditions of the UPS parallel system 10 or user requirements, for example, m may be 2%, 4%, or 5%.

In some embodiments of the present disclosure, the controller 107 may further be configured to: compare the output frequency f1 with the first frequency threshold fth1, the output frequency f1 with the second frequency threshold fth2, and a bypass frequency fp of the discrete bypass 103 with a first frequency range fr respectively when the uninterruptible power supply UPS 1 and the other uninterruptible power supplies UPS 2 to UPS n are in the power conversion mode or the battery mode, and determine that the switch state of the output switch S1 is open when the output frequency f1 is less than the first frequency threshold fth1 or the output frequencyf1 is greater than the second frequency threshold fth2 and the bypass frequency fp is within the first frequency range fr. Wherein, the bypass frequency fp is an input frequency of the discrete bypass 103 that is obtained by the controller 107. In this embodiment, the bypass frequency fp is the output frequency of the first alternating current power supply 12.

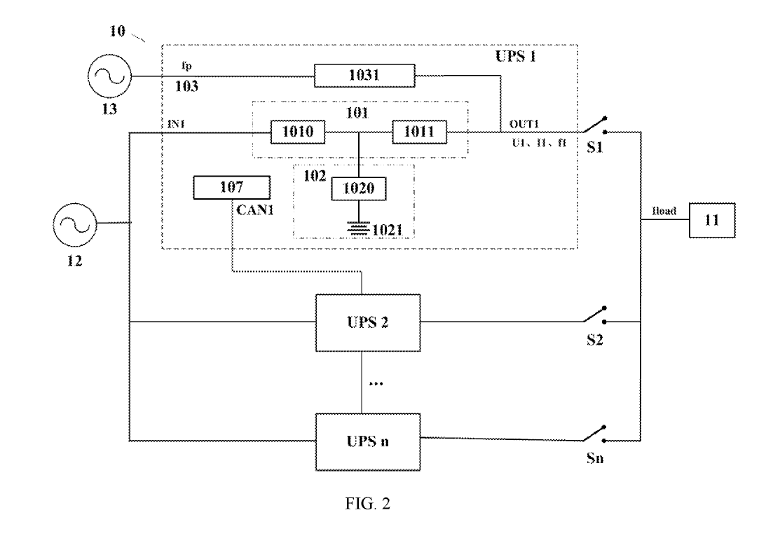

FIG. 2 illustrates a schematic circuit diagram of a UPS and a UPS parallel system thereof according to another embodiment of the present disclosure. Wherein, as shown in FIG. 2, an input side of the discrete bypass 103 of UPS 1 is electrically connected to a second alternating current power supply 13, and an output side of the discrete bypass 103 is electrically connected to an output terminal OUT1. In this embodiment, the bypass frequency fp is an output frequency of the second alternating current power supply 13.

In some embodiments of the present disclosure, the controller 107 may further be configured to: compare the output frequency f1 with the first frequency threshold fth1, the output frequency f1 with the second frequency threshold fth2, and the output current I1 with the second current threshold Ith2 respectively when the uninterruptible power supply UPS 1 and the other uninterruptible power supplies UPS 2 to UPS n are in the power conversion mode or the battery mode, and determine that the switch state of the output switch S1 is open when the output frequency f1 is less than the first frequency threshold fth1 or the output frequency f1 is greater than the second frequency threshold fth2 and the output current I1 is less than the second current threshold Ith2. When the output switch S1 is open, the electrical connection between UPS 1 and system load 11 is cut off, and the output current I1 of UPS 1 will significantly decrease (close to zero) and cannot participate in load power distribution. At this point, the other parallel UPSs (such as UPS 2 to UPS n) actively respond to a load demand and increase their output frequencies (such as entering an overload frequency modulation mode) to increase power output, thereby maintaining a stable system frequency. If the controller 107 detects that the output frequency f1 of UPS 1 exceeds a normal threshold range (such as f1<fth1 or f1>fth2) due to disconnection from the load, and the output current I1 of UPS 1 is less than the threshold Ith2 due to disconnection from an associated path, it can be determined that S1 is in an open state. This mechanism utilizes the frequency coupling characteristics between UPSs in the parallel system and the correlation logic of load dynamic response, and can achieve state diagnosis without relying on physical sensors.

In some embodiments of the present disclosure, the controller 107 may further be configured to: compare the output frequency f1 with the first frequency threshold fth1, the output frequency f1 with the second frequency threshold fth2, the bypass frequency fp of the discrete bypass 103 with the first frequency range fr, and the output current I1 with the second current threshold Ith2 respectively when the uninterruptible power supply UPS 1 and the other uninterruptible power supplies UPS 2 to UPS n are in the power conversion mode or the battery mode, and determine that the switch state of the output switch S1 is open when the comparisons simultaneously meet the following requirements:

the output frequency f1 is less than the first frequency threshold fth1 or the output frequency f1 is greater than the second frequency threshold fth2;

the bypass frequency fp is within the first frequency range fr; and

the output current I1 is less than the second current threshold Ith2.

In this solution, the determination of the bypass frequency fp is added to exclude the interference of input circuit abnormalities (such as fluctuations in utility power frequency) with switch state detection. For example, when the UPS is in the power conversion mode, if the bypass frequency fp of the first alternating current power supply 12 (such as utility power) as an input is within the normal range fr, it indicates that there is no significant abnormality on the input side (such as stable utility power frequency). At this point, if the output frequency f1 of UPS 1 deviates from the threshold (f1<fth1 or f1>fth2) and the output current I1 is less than the threshold Ith2, frequency offsets caused by input side problems can be excluded, thereby further clarifying that the root cause of the abnormality is the disconnection of output switch S1. By correlating the logical relationship between the bypass frequency and the output frequency of UPS, the robustness of state determination can be improved, and erroneous determination caused by transient fluctuations on the input side (such as short-term frequency disturbances) can be avoided.

In some embodiments of the present disclosure, the first frequency range fr is related to a rated output frequency of an alternating current power supply connected to the input side of the discrete bypass 103.

In some embodiments of the present disclosure, the controller 107 may further be configured to: compare the output voltage U1 with a first voltage threshold Uth1 and the output current I1 with the second current threshold Ith2 respectively when the uninterruptible power supply UPS 1 is in the power-off mode and some of the other uninterruptible power supplies UPS 2 to UPS n are in the power conversion mode or the battery mode, and determine that the switch state of the output switch S1 is open when the output voltage U1 is less than the first voltage threshold Uth1 and the output current I1 is less than the second current threshold Ith2.

In some embodiments of the present disclosure, the first voltage threshold Uth1 may be determined based on actual operating conditions of the UPS parallel system 10 or user requirements, such as 100 V.

In some embodiments of the present disclosure, the controller 107 may be configured to determine the switch state of the output switch S1 based on users’ instructions; and the controller 107 may further be configured to periodically determine the switch state of the output switch S1 according to a preset determination cycle T, that is, the controller 107 determines the switch state of the output switch S1 once within each determination cycle T. The determination cycle T may be determined based on actual operating conditions of the UPS parallel system 10 or user requirements, such as 500 ms or 1s.

In some embodiments of the present disclosure, the controller 107 may further be configured to indicate the switch state of the output switch S1 to a user after at least two consecutive determinations that the switch state of the output switch S1 is open. For example, the controller 107 outputs an indication to the user that the switch state of the output switch S1 is open after three consecutive determinations that the switch state of output switch S1 is open.

Embodiments of the present disclosure further provide a control method for an uninterruptible power supply. The control method may be used to determine a switch state of an output switch (such as output switch S1 shown in FIGS. 1-2) connected in series between an output terminal of the uninterruptible power supply and a system load. The control method includes the following steps:

Step 1: Obtain a operating mode, an output current I1, an output voltage U1, and an output frequency f1 of the uninterruptible power supply UPS 1, and a load current Iload of the system load 11;

Step 2: Obtain operating modes of the other uninterruptible power supplies UPS 2 to UPS n through a communication module CAN1 communicatively connected to the other uninterruptible power supplies UPS 2 to UPS n electrically connected between a first alternating current power supply 12 and the system load 11; and

Step 3: Determine a switch state of the output switch S1 based on i) at least one of the output voltage U1 and output frequency f1 of the uninterruptible power supply UPS 1 and the load current Iload of the system load 11, ii) the output current I1 of the uninterruptible power supply UPS 1, and iii) the operating modes of the uninterruptible power supply UPS 1 and the other uninterruptible power supplies UPS 2 to UPS n.

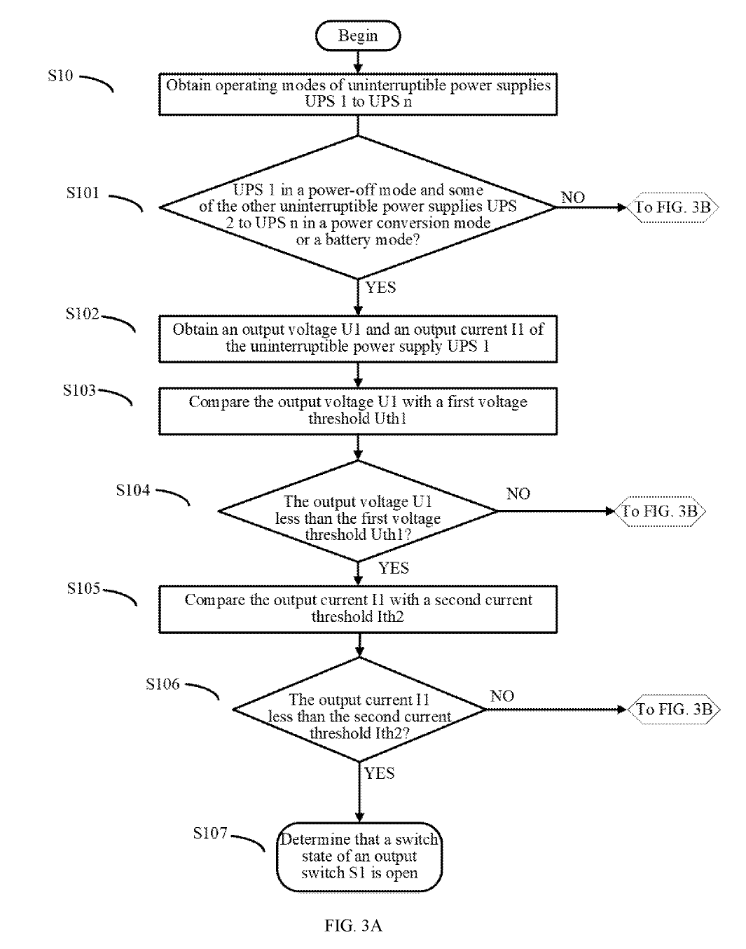

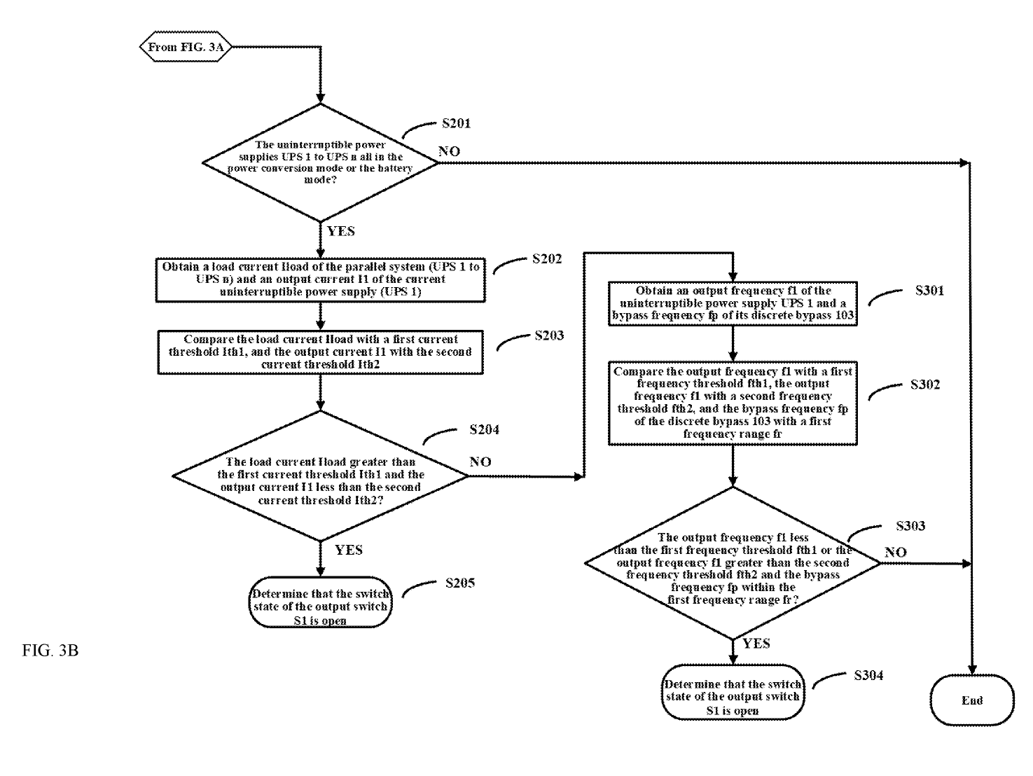

FIGS. 3A and 3B illustrate a flowchart of a control method for an uninterruptible power supply according to an embodiment of the present disclosure. As shown in FIGS. 3A and 3B, the control method includes the following steps:

S10: Obtain operating modes of uninterruptible power supplies UPS 1 to UPS n.

S101: Determine whether UPS 1 is in a power-off mode and some of the other uninterruptible power supplies UPS 2 to UPS n are in a power conversion mode or a battery mode. If UPS 1 is in the power-off mode and some of the other uninterruptible power supplies UPS 2 to UPS n are in the power conversion mode or the battery mode, step S102 is performed. Otherwise, step S201 is performed.

S102: Obtain an output voltage U1 and an output current I1 of the uninterruptible power supply UPS 1.

S103: Compare the output voltage U1 with a first voltage threshold Uth1.

S104: Determine whether the output voltage U1 is less than the first voltage threshold Uth1. If the output voltage U1 is less than the first voltage threshold Uth1, step S105 is performed. Otherwise, if the output voltage U1 is not less than the first voltage threshold Uth1, step S201 is performed.

S105: Compare the output current I1 with a second current threshold Ith2.

S106: Determine whether the output current I1 is less than the second current threshold Ith2. If the output current I1 is less than the second current threshold Ith2, step S107 is performed. Otherwise, if the output current I1 is not less than the second current threshold Ith2, step S201 is performed.

S107: Determine that a switch state of an output switch S1 is open.

S201: Determine whether the uninterruptible power supplies UPS 1 to UPS n are all in the power conversion mode or the battery mode. If the uninterruptible power supplies UPS 1 to UPS n are all in the power conversion mode or the battery mode, step S202 is performed. Otherwise, the process is ended.

S202: Obtain a load current Iload of the parallel system (UPS 1 to UPS n) and an output current I1 of the current uninterruptible power supply (UPS 1).

S203: Compare the load current Iload with a first current threshold Ith1, and the output current I1 with the second current threshold Ith2.

S204: Determine whether the load current Iload is greater than the first current threshold Ith1 and the output current I1 is less than the second current threshold Ith2. If the load current Iload is greater than the first current threshold Ith1 and the output current I1 is less than the second current threshold Ith2, step S205 is performed. Otherwise, step S301 is performed.

S205: Determine that the switch state of the output switch S1 is open.

S301: Obtain an output frequency f1 of the uninterruptible power supply UPS 1 and a bypass frequency fp of its discrete bypass 103.

S302: Compare the output frequency f1 with a first frequency threshold fth1, the output frequency f1 with a second frequency threshold fth2, and the bypass frequency fp of the discrete bypass 103 with a first frequency range fr.

S303: Determine whether the output frequency f1 is less than the first frequency threshold fth1 or the output frequency f1 is greater than the second frequency threshold fth2 and the bypass frequency fp is within the first frequency range fr. If the output frequency f1 is less than the first frequency threshold fth1 or the output frequency f1 is greater than the second frequency threshold fth2 and the bypass frequency fp is within the first frequency range fr, step S304 is performed. Otherwise, the process is ended.

S304: Determine that the switch state of the output switch S1 is open.

In the embodiments of the present disclosure, any combination or sequence adjustment of steps S101 to S107, steps S201 to S205, and steps S301 to S304 can be performed according to actual needs. For example, in some embodiments of the present disclosure, the switch state of the output switch S1 is determined by performing steps S10, S101 to S107, and S201 to S205. In other embodiments of the present disclosure, the switch state of the output switch S1 is determined by performing steps S10 and S201 to S205. In still other embodiments of the present disclosure, the switch state of the output switch S1 is determined by performing steps S10, S101 to S107, S201 to S205, and S301 to S304. Therefore, the flexible combination of different detection logics can adapt to the needs of different application scenarios, not only improve system security (such as multi-mode detection), but also optimize execution efficiency (such as detecting only critical modes). Meanwhile, the modular design allows the user to choose appropriate detection strategies based on actual needs, with reliability and flexibility.

The present disclosure provides an uninterruptible power supply and a control method thereof, which implement innovative breakthrough on multiple bottlenecks of output switch state detection technology in existing UPS parallel systems. The present disclosure constructs a dynamic decision-making mechanism based on multi-dimensional parameter collaborative analysis by obtaining key parameters such as an output current, an output voltage, an output frequency, and a bypass frequency of an uninterruptible power supply, a load current of a system load, and operating modes of other uninterruptible power supply in the UPS parallel system of uninterruptible power supplies, thereby achieving accurate determination on an output switch state. Compared with the prior art, the present disclosure, based on the inherent characteristics of uninterruptible power supply, replaces hardware sensors with software algorithms, thereby not only eliminating technical obstacles in device adaptation, installation, and maintenance, saving relevant manpower and material resources, but also fundamentally overcoming technical defects of hardware sensors such as signal delay, poor contact, and weak anti-interference capability, and enabling quick and accurate determination of the output switch state.

The reference to "various embodiments", "some embodiments", "one embodiment", "embodiments", or the like in the specification means that specific features, structures, or properties described with reference to the embodiments are included in at least one embodiment. Therefore, the phrase "in various embodiments", "in some embodiments", "in one embodiment", "in embodiments", or the like does not necessarily refer to the same embodiment throughout the specification. In addition, the specific features, structures, or properties may be combined in any suitable manner in one or more embodiments. Therefore, the specific features, structures, or properties shown or described with reference to one embodiment may be combined, in whole or in part without limitation, with the features, structures, or properties of one or more other embodiments, provided that the combination is not non-logical or inoperable.

The terms "include" and "have" as well as term expressions with a similar meaning in the specification are intended to cover a non-exclusive inclusion, for example, a process, a method, a system, a product, or a device that includes a series of steps or units is not limited to the listed steps or units, but optionally further includes an unlisted step or unit, or optionally further includes another step or unit inherent to the process, the method, the product, or the device. "An" or "one" does not exclude multiple cases. In addition, the various elements in the accompanying drawings of the present disclosure are merely used for schematic description, and are not drawn in a scale.

Although the present disclosure has been described through preferred embodiments, the present disclosure is not limited to the embodiments described herein, but further includes various changes and variations made without departing from the scope of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An uninterruptible power supply, comprising:
an input terminal configured to be electrically connectable to a first alternating current power supply;
an output terminal configured to be electrically connectable to one side of an output switch that is, on the other side of the output switch, configured to be electrically connectable to a system load;
a communication module communicatively connected to additional uninterruptible power supplies electrically connected between the first alternating current power supply and the system load, wherein a corresponding output switch is connected in series between each uninterruptible power supply among the additional uninterruptible power supplies and the system load, and the communication module is configured to obtain operating modes of the additional uninterruptible power supplies, the operating modes comprising a power conversion mode, a battery mode, a bypass mode, and a power-off mode; and
a controller configured to determine a switch state of the output switch based on i) at least one of an output voltage and an output frequency of the uninterruptible power supply and a load current of the system load, ii) an output current of the uninterruptible power supply, and iii) operating modes of the uninterruptible power supply and the additional uninterruptible power supplies.

2. The uninterruptible power supply according to claim 1, wherein the controller is further configured to:
determine the switch state of the output switch further based on i) any two or three of the output voltage and the output frequency of the uninterruptible power supply and the load current of the system load, ii) the output current of the uninterruptible power supply, and iii) the operating modes of the uninterruptible power supply and the additional uninterruptible power supplies.

3. The uninterruptible power supply according to claim 1, wherein the controller is further configured to:
compare the load current with a first current threshold and the output current with a second current threshold respectively when the uninterruptible power supply and the additional uninterruptible power supplies are in the power conversion mode or the battery mode, and determine that the switch state of the output switch is open when the load current is greater than the first current threshold and the output current is less than the second current threshold.

4. The uninterruptible power supply according to claim 1, wherein the controller is further configured to:
compare the output frequency with a first frequency threshold and the output frequency with a second frequency threshold respectively when the uninterruptible power supply and the additional uninterruptible power supplies are in the power conversion mode or the battery mode, and determine that the switch state of the output switch is open when the output frequency is less than the first frequency threshold or the output frequency is greater than the second frequency threshold.

5. The uninterruptible power supply according to claim 4, further comprising a discrete bypass, wherein an input side of the discrete bypass is electrically connected to a second alternating current power supply, and an output side of the discrete bypass is electrically connected to the output terminal,
wherein the controller is further configured to:
compare a bypass frequency of the discrete bypass with a first frequency range, and determine that the switch state of the output switch is open when the output frequency is less than the first frequency threshold or the output frequency is greater than the second frequency threshold, and the bypass frequency is within the first frequency range.

6. The uninterruptible power supply according to claim 4, wherein the controller is further configured to:
compare the output current with a second current threshold, and determine that the switch state of the output switch is open when the output frequency is less than the first frequency threshold or the output frequency is greater than the second frequency threshold, and the output current is less than the second current threshold.

7. The uninterruptible power supply according to claim 1, wherein the controller is further configured to:
compare the output voltage with a first voltage threshold and the output current with a second current threshold respectively when the uninterruptible power supply is in the power-off mode and some of the additional uninterruptible power supplies are in the power conversion mode or the battery mode, and determine that the switch state of the output switch is open when the output voltage is less than the first voltage threshold and the output current is less than the second current threshold.

8. The uninterruptible power supply according to claim 1, wherein the controller is further configured to periodically determine the switch state of the output switch according to a preset determination cycle.

9. The uninterruptible power supply according to claim 1, wherein the controller is further configured to indicate the switch state of the output switch to a user after at least two consecutive determinations that the switch state of the output switch is open.

10. The uninterruptible power supply according to claim 3, wherein the first current threshold is a sum of rated output currents of the uninterruptible power supply and the additional uninterruptible power supplies and the second current threshold is determined based on the rated output current of the uninterruptible power supply.

11. The uninterruptible power supply according to claim 4, wherein the first frequency threshold and the second frequency threshold are determined based on an output frequency of the first alternating current power supply.

12. The uninterruptible power supply according to claim 5, wherein the first frequency range is determined based on an output frequency of the second alternating current power supply.
